(19) United States
(12) Patent Application Publication
(10) Pub. No.: US 2016/0297552 A1
(43) Pub. Date: Oct. 13, 2016

(54) Deployable Device for the Thermal Insulation of Cryonic Tanks of Spacecraft

(71) Applicant: RUAG Space GmbH, Vienna (AT)

(72) Inventors: Martin MOSER, Vienna (AT); Walter HOIDN, Etsdorf am Kamp (AT)

(21) Appl. No.: 15/094,322

(22) Filed: Apr. 8, 2016

(30) Foreign Application Priority Data
Apr. 9, 2015 (EP) 15 450 017.7

(51) Int. Cl. B64G 1/58; B64G 1/40; B64G 1/22

(52) U.S. Cl. CPC B64G 1/58; B64G 1/222; B64G 1/402

(57) ABSTRACT

In a deployable device for the thermal insulation of cryogenic tanks (2) of spacecraft (1), including at least one insulating mat (8), preferably a plurality of insulating mats (8) distributedly arranged in the peripheral direction of the tank, and deployment means each associated to the insulating mat(s) (8) for unrolling the insulating mat(s) (8) from the rolled-up state into the extended state, the deployment means comprises at least one shape-changing element (7) extending in the unrolling direction, which is connected to, or integrated with, the insulating mat (8) and capable of being unrolled from the rolled-up state into the extended state by a controlled change in shape.

### CROSS-REFERENCE TO RELATED APPLICATION

This U.S. Application claims the foreign priority benefit of EP application 15 450 017.7, filed Apr. 9, 2015, the complete disclosure of which is hereby incorporated by reference.

### FIELD OF THE INVENTION

The invention relates to a deployable device for the thermal insulation of cryogenic tanks of spacecraft, including at least one insulating mat, preferably a plurality of insulating mats distributedly arranged in the peripheral direction of the tank, and deployment means each associated to the insulating mat(s) for unrolling the insulating mat(s) from the rolled-up state into the extended state.

### BACKGROUND

Rockets are fueled with liquid, i.e. cryogenic, fuels such as hydrogen or oxygen because of their higher energy density. In order to minimize the evaporation rate of the liquid fuel, these tanks are insulated, usually with foam insulating systems on their inner sides and with sprayed-on foam insulations on their outer sides. The external insulation is kept in white in order to reduce the input of heat by solar radiation. However, the frictional heat generated at the launch of a rocket causes the external foam insulation to darken, thus increasing the heat input into the tank when in orbit.

Insulating materials currently used to protect rocket tanks for cryogenic fuels from the evaporation of the liquid typically comprise foams of polyvinylchloride, polyurethane, or polyetherimide. These foams are either glued in thicknesses of 20-200 mm or directly sprayed onto the surface of the tank (EP 1878663 A1, EP 2354621 A1). To counteract the degradation of the insulating effect caused by the darkening and ablation of the insulating material, panels can be used, which protect the insulating material, in particular foam, underneath the panel during takeoff and will be jettisoned after the first flight phase. Yet, such panels are themselves subject to complex mechanical launch stresses and reduce the accessibility to the upper stage of the rocket. The necessary connection to the structure causes the creation of thermal bridges minimizing the potential for improvement and the effect of the multilayer insulation or foams located therebehind.

Furthermore, various configurations of sunshields have been proposed, which are provided to shield rocket tanks for cryogenic fuels from radiation in the orbit. Such sunshields are usually designed to be unfoldable or deployable. They are in the collapsed or folded state during the take-off phase and will not be unfolded before they have reached the orbit. In the subject matter of U.S. Pat. No. 8,196,869 B2, the sunshield comprises a plurality of insulating mats distributedly arranged about the periphery of the tank, and actuators each associated to the insulating mats for unrolling the insulating mats from the rolled-up state into the extended state. The mats are each wound on a roll and rolled off the same by the aid of a pneumatically actuated mechanism. The insulating mats are extended in such a manner as to form a conical shield. The roll-off mechanism thus requires a stationary roller and a suitable holding means as well as a separate, external actuator, from which result a considerable space demand and a complex, high-mass construction prone to failure. The high-mass construction imposes a mass penalty against the spacecraft, such as a rocket, especially in lift off before the spacecraft achieves orbit.

### SUMMARY

The deployable device for the thermal insulation of cyonic tanks of a spacecraft offers an improved device with advantages, with the result that the following requirements are at least partially met:
High thermal insulation degree in vacuum enables a lower evaporation rate of the cryogenic fuel, and hence an extended operating time of the upper stage,
Low mass
Compact construction
Versatility:
The system is to be used only in such missions where long operating times and/or multiple ignitions of the upper stage are required.
Moreover,
   the permanent structural and mechanical entries on the upper stage, such as joints, connections and the like can be minimized,
   the permanent entries into the control and software of the rocket can be minimized,
   the installation of the system can be performed in a simple manner and without involving conversions of the upper stage, and
   the system is even installable even late in the integration sequence.

Additionally, the deployable insulation system is readily adaptable so as to be usable with different types of spacecraft (such as a rocket by way of example). Advantageously, this provides greater flexibility because the system can be used with different types of such spacecraft, including rockets.

Furthermore, the accessibility to the (sub)systems of the rocket may not be limited or is at least not as constrained as compared to other systems, while enabling sufficient resistance to mechanical and thermal loads to be ensured, in particular during the rocket launch phase. For instance, resistance to environmental impacts must be ensured such as during launch preparation (rain, wind, humidity etc.) and also once in orbit (radiation, temperature cycles etc.). Also, forces resulting from the stabilizing rotation of the upper stage and accelerations due to the ignition of the rocket engine are to be withstood in the orbit. The present system having lower mass means there is benefit in initiating, achieving or adjusting stabilizing rotations in orbit.

The system complies with the cleanliness requirement specification “visible clean” according to ECSS-Q-ST-70-010C and a permitted outgassing behavior according to ECSS-Q-70-02 in order to avoid cross-contamination of the payload.

In achieving these and other objectives, a present device can consist essentially of structure in which the deployment means comprises at least one shape-changing element extending in the unrolling direction, which is connected to, or integrated with, at least one insulating mat and capable of being unrolled from the rolled-up state into the extended state by a controlled change in shape. The deployment of the insulating mat(s) thus is accomplished by shape-changing element(s) which are each kept in store with the associated insulating mat in the rolled-up state and will cause the unrolling of the insulating mat(s) by an appropriately controlled change in shape. The controlled change in shape is preferably performed such that the at least one shape-changing element is forced from the rolled-up shape into the extended shape. In doing so, the shape-changing element carries along the insulating mat connected thereto, so as to cause a corresponding change in shape, i.e. unrolling, of the insulating mat. Due to the configuration according to a present deployable device invention, the deployment means do not require a separate installation volume, thus providing a particularly space-saving structure. Another advantage of the system resides in the low degree of complexity and the thus resulting variability of application, as well as reduced mass compared to structures heretofore proposed.

### BRIEF DESCRIPTION OF THE FIGURES

FIG. 1 illustrates the upper stage of a rocket with an exemplary embodiment of the present the insulating device in the rolled-up state.

FIGS. 2 to 5 depict the individual stages of the deployment process in detailed views.

FIG. 6 shows the upper stage with an exemplary embodiment of the deployed insulating device.

FIG. 7 is a schematic illustration of an insulating mat.

FIG. 8 illustrates the unrolling process.

FIGS. 9 and 10 are detailed views of two stages of deployment in the region of an angulation of a shape-changing element of the insulating mat.

### DETAILED DESCRIPTION

A deployable device for the thermal insulation of cryogenic tanks (2) of spacecraft (1), includes at least one insulating mat (8), although preferably a plurality of insulating mats (8) are distributedly arranged in the peripheral direction (e.g. outer periphery) of the tank, and deployment means each associated with the insulating mat(s) (8) for unrolling the insulating mat(s) (8) from the rolled-up state into the extended state, wherein the deployment means comprises at least one shape-changing element (7) extending (e.g., extendable) in the unrolling direction, which is connected to, or integrated with, the insulating mat (8) and capable of being unrolled from the rolled-up state into the extended state by a controlled change in shape.

The change in shape of the shape-changing element can be effected in various ways using the actor principles suitable for aerospace applications, e.g. by the aid of an integrated spring or shape memory element, or a bimetal actor. It is, however, preferably provided that the shape-changing element comprises at least one cavity to which medium under pressure can be fed, e.g., to inflate the cavity. Thus, in a particularly advantageous embodiment, the shape-changing element is pneumatically actuatable, whereby the change in shape is effected to attain a predefined shape of the shape-changing element upon deployment resulting from inflating the cavity.

In this context, it is provided in a particularly preferred manner that the shape-changing element, upon deployment, forms an inflatable spar extending in the unrolling direction substantially over the entire length of the insulating mat and connected to, or integrated with, the insulating mat. In the inflated state, such a spar may, for instance, have a circular cross section, with a small diameter so as to apply the force required for unrolling the insulating mat. The inflatable spar preferably extends over the unrollable length of the insulating mat. An insulating mat is preferably equipped with at least two parallel spars extending in the roll-out direction, wherein it will be beneficial to arrange the two spars on the two side edges of the insulating mat. A third spar, or several further spars, may optionally be arranged in the middle between the two edge-side spars.

Automatic unrolling merely by the action of the shape-changing element will, in particular, be successful if, as in correspondence with a preferred configuration of the invention, the radially outer free end of the insulating mat, viewed in the rolled-up state, is fastened to the spacecraft, in particular a payload adapter of the spacecraft. Unlike in other cases where the insulating mat is rolled up on a central shaft, the insulating mat is thus fastened to the radially outer free end rather than the radially inner free end. This enables direct fixation such that separate components such as a rotationally mounted shaft plus bearing, can be renounced. No permanent installations are therefore required on the spacecraft, because the rolled-up installation mat integrally incorporates the unrolling mechanism. The only thing necessary is a connection of the actuator required for the controlled change in shape of the shape-changing element, such as the supply of inflation medium.

In order to allow the unrolling of the insulating mat to proceed as smoothly as possible, a preferred configuration provides that the insulating mat and/or the shape-changing element is/are equipped with a braking device counteracting the unrolling movement. The braking device in this case advantageously comprises a releasable connection, in particular a hook-and-loop connection, between superimposed layers of the rolled-up insulating mat and/or shape-changing element.

The shape-changing element rolled up with the insulating mat in a simple manner allows for the adaptation of the shape to be assumed after unrolling. With the appropriate design of the shape-changing elements, it is thus possible to impart to the insulating mats, in the extended state, such a final shape that the insulating mats will largely follow the contour of the tank to be shielded. A preferred configuration in this context provides that the shape-changing element forms an angulation in the extended state. Where the shape-changing element is designed as a pneumatically inflatable spar or the like, such angulation will be readily achieved in that the spar is preformed in such a manner as to reach the desired shape in the inflated state.

The angulation is preferably arranged such that the insulating mat, departing from its fixation to the payload adapter of the spacecraft, extends along the end-side surface of the tank in a first portion, is deflected in the region of the peripheral edge, and extends substantially in parallel with the, in particular, cylindrical wall of the tank in a consecutive, second portion.

The insulating mats are preferably arranged in such a manner as to collectively form a polygonal, cylindrical jacket around the tank. The number or corners of the polygon corresponds to the number of insulating mats.

In order to achieve uninterrupted shielding of the tank, it is preferably provided that adjacent insulating mats overlap each other.

The device according to the invention is preferably used on the upper stage of a rocket to shield the cryogenic tank of the upper stage from solar radiation.

A present deployable device can not only counteract an elevated heat input but can also reduce the heat input into the tank, and hence the evaporation rate of the cryogenic fuel. The reduction in evaporation resulting from the heat reduction achievable is to such an extent so as to enable the engine of an upper stage to be restarted several times and over an extended period. It has thus become possible to release satellites in different orbits and increase the flexibility of rockets.

The insulation system can be mounted to the payload adapter and will be protected under the payload fairing during the launch. It will be deployed in the orbit after the payload has been jettisoned. The deployment is preferably performed purely pneumatically by unrolling and is preferably braked, such as by hook-and-loop tapes. Advantageously, this system is independent of the surface geometry of the rocket stage and, if required or desored, can be used in addition to the basic insulation of the rocket.

In the following, the invention will be explained in more detail by way of an exemplary embodiment schematically illustrated in the drawings.

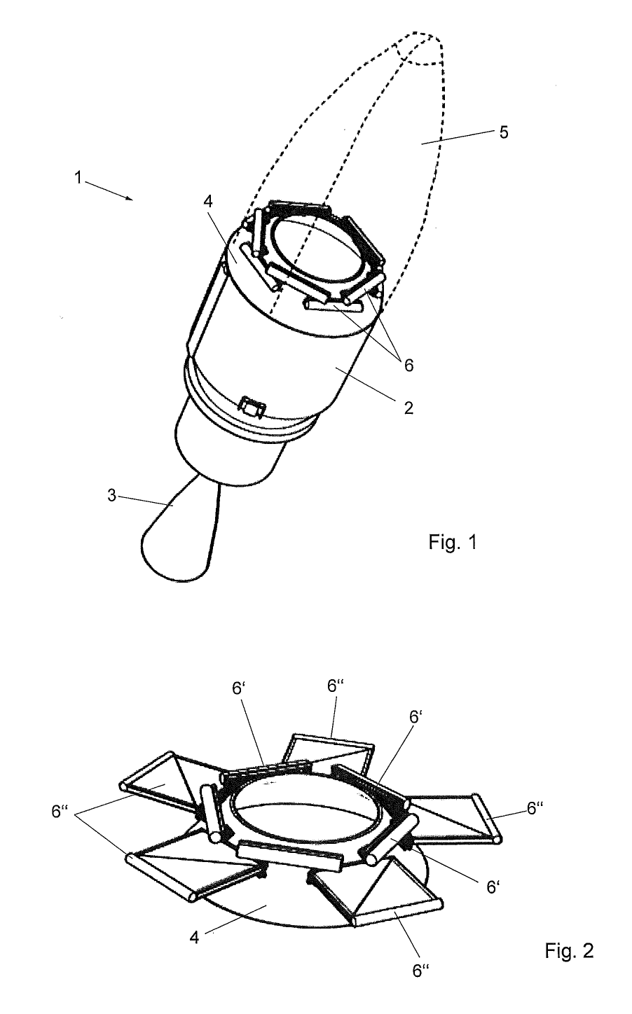

FIG. 1 illustrates the upper stage 1 of a rocket, which comprises a cryogenic tank 2 for supplying a rocket engine 3, and a payload adapter 4. The payload (not illustrated) is disposed underneath a payload fairing 5 indicated by broken lines. The insulating device according to the invention is mounted to the payload adapter 4 and comprises several segments 6. The segments 6 circumscribe a circle arranged concentrically with the rocket axis and are arranged about this circle, i.e. distributed in the circumferential direction. The segments 6 are subdivided into two groups, the segments 6′ of the first group and the segments 6″ of the second group alternating in the circumferential direction. The segments 6′ of the first group are arranged to be offset relative to the segments 6″ of the second group. In particular the segments 6′ of the first group circumscribe a circle with a smaller diameter than the segments 6″ of the second group. This enables the arrangement of adjacent segments 6′, 6″ in a mutually overlapping manner. All of the segments 6 can be identically constructed and mutually interchangeable.

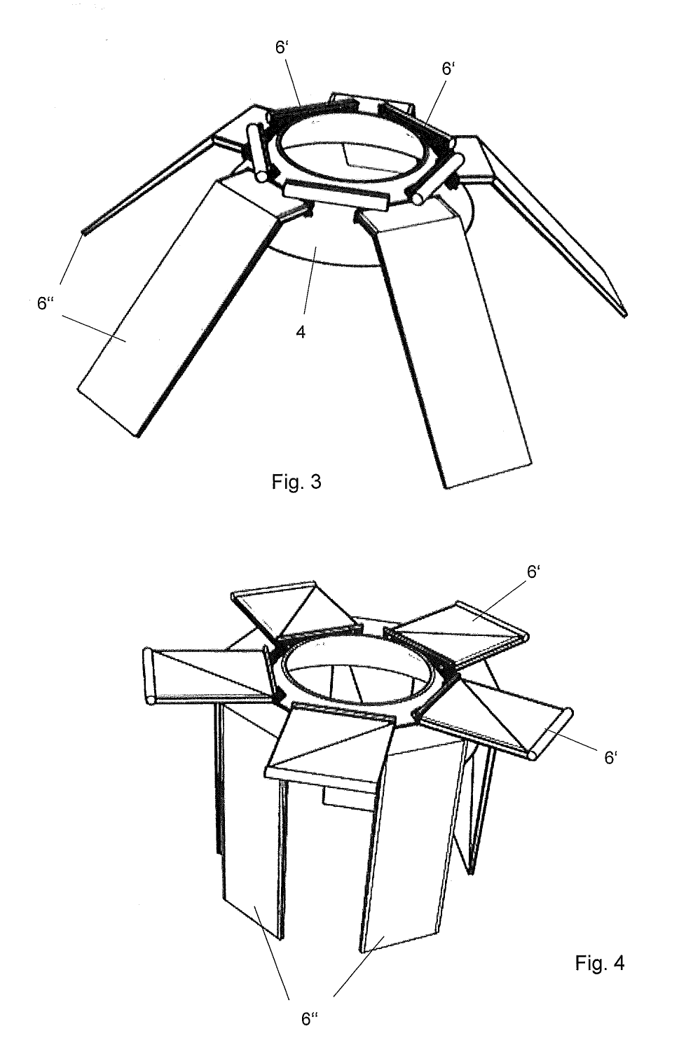

During launch preparation, fuelling and the first flight phase of the rocket 1, the segments 6 are rolled in and completely stowed underneath the payload fairing 5, thus being protected from environmental impacts and launch loads (FIG. 1). After the payload fairing 5 has been jettisoned, the system is sequentially deployed over the cryogenic tank 2 of the rocket upper stage 1. At first, the farther inwardly arranged segments 6′ of the first group are horizontally unrolled (FIG. 2), then controlledly configured (e.g., bent) (FIG. 3), and brought into the final shape over the cryogenic tank 2 (FIG. 4). The farther outwardly arranged segments 6″ of the second group are still stowed during this process.

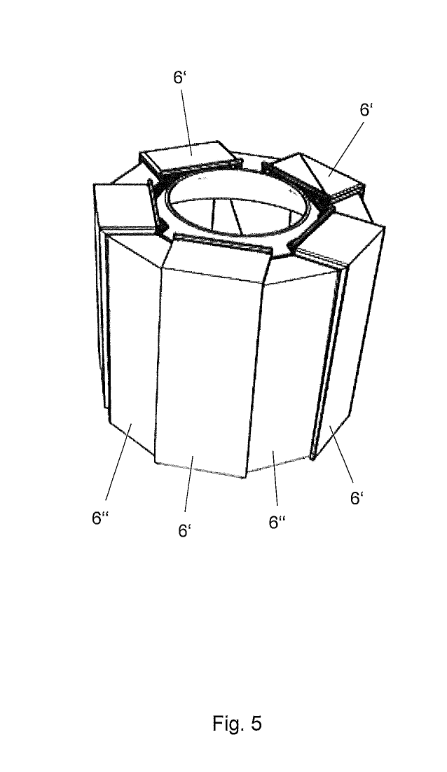

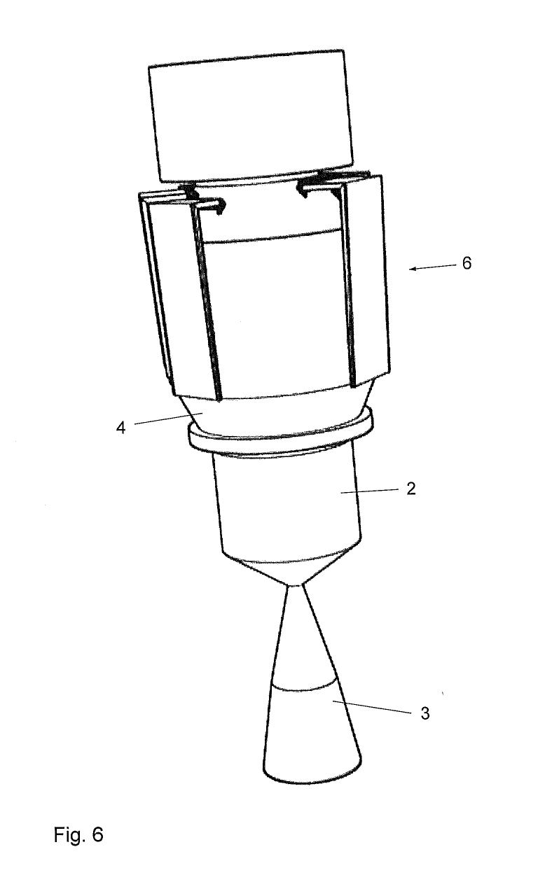

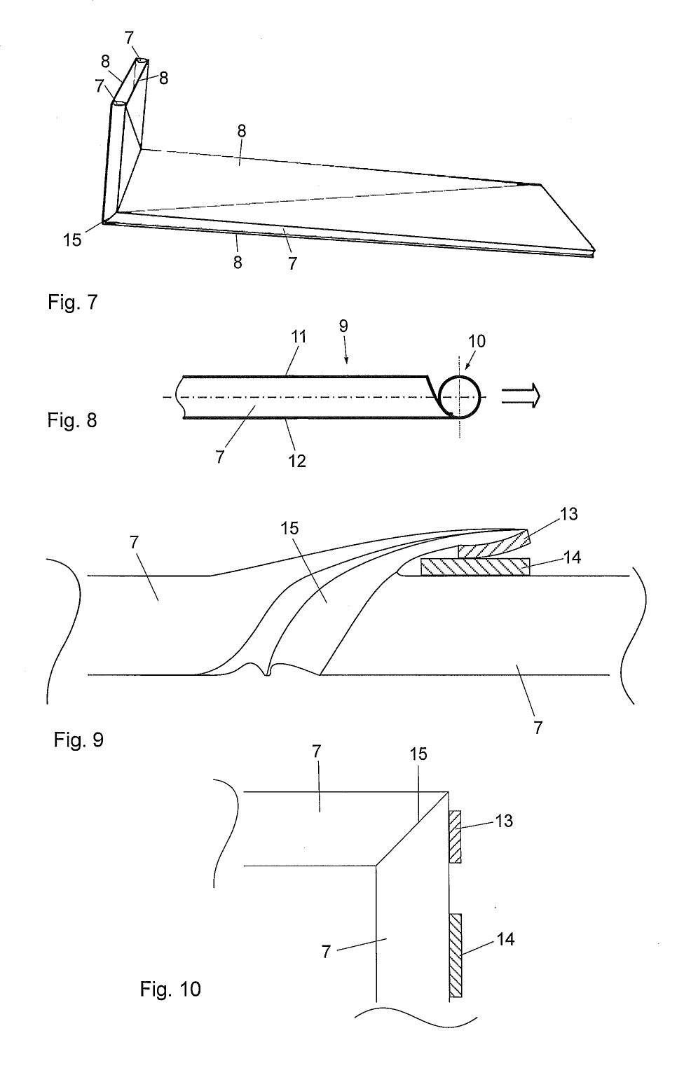

Subsequently, the deployment of the segments 6″ of the second group takes place after the process steps of horizontally extending (FIG. 4), bending (FIG. 5), and covering the tanks 2 (FIG. 5). The segments 6″ of the second group are arranged in such a manner as to cover the edge region of the segments 6′ of the first group. Direct solar radiation during the rotation of the upper stage will thus be avoided.

In a preferred aspect, the deployment process occurs pneumatically. Each of the segments is comprised of an insulating system of hollow bodies that can be powered or filled with medium under pressure, in particular spars 7, which are lined with, and connected to, insulating mats 8. The spars 7 are preshaped to their final shapes and made of approved aerospace materials such as, for instance, polyethyleneterephthalate (PET, Mylar®), polyimide (PI, Kapton®, Upilex®) or polyetheretherketone (PEEK) and can be glued and additionally reinforced with tissues or jacketed. The spars 7 are shaped as a function of the configuration and geometry of the upper stage such that, in the final shape, a bend α of a few degrees up to more than 100° will be achieved.

Two or more deployable spars 7 per segment 6 can be compressed by, or filled with, a gaseous medium, in particular nitrogen or helium. The spars 7 thus form shape-changing elements which are initially (FIG. 1) rolled-up and, by being filled with gaseous medium, exert a force progressing in the unrolling direction in the sense of assuming their pregiven shape. Said force causes the progressive unrolling of the insulating mats 8. The insulating mats 8 can be comprised of a single- or multi-layer insulation or other materials, e.g. foams or tissues.

The unrolling process takes place merely pneumatically, free of any mechanical components. The unrolling process is schematically illustrated in FIG. 8. In a first portion 9 of the insulating mat 8, the latter has already been unrolled, and the spars 7 in this portion have been filled with medium and inflated. In a second portion 10, the insulating mat 8 is still in the rolled-up state.

Unrolling is braked, such as by hook-and-loop tapes, so as to enable the achievement of a smooth movement. A hook-and-loop tape 11 designed as a hook tape is attached to one side of the spar 7, and a hook-and-loop tape designed as a loop tape is applied to the other side of the spar 7, the hook tape and the loop tape thus cooperating in the rolled-up state of the spar 7. When applying the pressure in the spars 7, a controlled unrolling movement will occur on the hook-and-loop tapes by the hook-and-loop connection being opened. The braking speed can be adjusted (e.g., controlled). For example, the unrolling speed can be adjusted via adjusting the pressure in the spars 7 and the geometry (width, type) of the hook-and-loop tapes.

As illustrated in FIGS. 9 and 10, the process of configuring (e.g., bending) is controlled by further hook-and-loop tapes 13 and 14 attached to the spars 7. To this end, each spar 7 is folded in the region of the angulation 15 in the non-compressed state such that a straight, horizontally oriented hollow body is formed (FIG. 9). The folding is closed by means of a hook-and-loop connection. When applying pressure, the hook-and-loop tape connection is released, and the spar 7 aims to assume the final L-shape by an oscillation movement (FIG. 10). Commonly available hook-and-loop tapes approved in aerospace, such as Velcro® or Scotchbrite® brand tapes or the like, can be used.

A present depolyable device (sometimes referred to as a system or deployable insulating system) can be characterized by a number of advantages, as described herein. By being fastened to the payload adapter, the system is independent of the geometry of the upper stage. Consequently the upper stage can be designed according to criteria established for conventional missions and the various upper stage structures in current use, while also allowing flexibility to accomdoate changes in upper stage design. If necessary, the deployable insulating system is additionally fixed by selecting the payload adapter provided therefor. A mechanical connection directly to the upper stage is not necessary. Thus, as compared to a conventional insulation an additional insulating effect is created, unlimited access to the upper stage and its subsystems is, moreover, provided, no additional thermal bridges are created, the upper stage need not lift additional mass (“mass penalty”) in the form of, e.g. linkages, connections and the like, at every launch, the system can be used on every upper stage with the same payload adapter, and, as mentioned, the system can be adapted to existing rocket types without necessarily requiring retrospective modification of the upper stage.

By being mounted underneath the payload fairing, the insulating system is protected from launch loads and environmental impacts during ground operations and the first launch phase. Additional structural components for protecting the system can be renounced, with the added benefit of reducing the mass. Unlike the prior art, the present deployable insulation system is fully optimized to its use in the vacuum of space. In a particularly advantageous aspect, due to the application of a multilayer insulation, a high degree of insulation is achieved by a low mass input.

The deployable system comprises materials and components already approved for aerospace applications. Pressure and control systems for helium or nitrogen correspond to the prior art and are widely used, for instance for cold-gas engines or for compressing satellite fuel tanks.

In a particularly advantageous aspect, the operative deployment of the present deployable device (e.g., deployable insulating system) can be effected facilely by merely pneumatically deployment without any additional mechanical components. This results in a small number of critical components and subsystems, a low complexity, ready and easy adaptability, and, as mentioned again, a low mass of the overall system. In short, as described herein, this pneumatically deployable thermal insulation for cryogenic rocket tanks is a particularly advantageous.

Consequently, a present deployable insulating system can also be used as a permanent component of the upper stage of a rocket. This allows the conventional tank insulation to be optimized for use on ground and the deployable insulation can be exclusively relied upon in space. This enables a reduction of the evaporation rate of the fuel on ground, a reduction of the thickness of the insulating foam permanently remaining on the upper stage, or, if desired, complete removal of the foam, and hence a still further additional mass reduction.

A modification of the system can be used for the variable covering of radiator surfaces on satellites. When requiring large radiator surfaces, i.e. a high radiating effect, the system will be in the stowed, rolled-up state. As soon as the environmental conditions call for a lower radiation effect, the insulating device will be pneumatically deployed and the radiator partially covered. A return movement, and hence a two-way system, can be achieved by an additional spring mechanism.

It will therefore be appreciated that the present invention includes a spacecraft (such as a rocket by way of example) having at least one tank for containing cryogenic material (such as liquid rocket fuel, as an example)equipped with at least one deployable insulating system as described herein.

1. A deployable device for the thermal insulation of cryogenic tanks of spacecraft, including at least one insulating mat, preferably a plurality of insulating mats distributedly arranged in the peripheral direction of the tank, and deployment means each associated to the insulating mat(s) for unrolling the insulating mat(s) from the rolled-up state into the extended state, characterized in that the deployment means comprises at least one shape-changing element (7) extending in the unrolling direction, which is connected to, or integrated with, the insulating mat (8) and capable of being unrolled from the rolled-up state into the extended state by a controlled change in shape.

2. A device according to claim 1, characterized in that the shape-changing element (7) comprises at least one cavity to which medium under pressure can be fed such that the unrolling process takes place merely pneumatically, free of any mechanical components.

3. A device according to claim 1, characterized in that the shape-changing element is formed by an inflatable spar (7) extending in the unrolling direction substantially over the entire length of the insulating mat (8) and connected to, or integrated with, the insulating mat (8).

4. A device according to claim 1, characterized in that the radially outer free end of the insulating mat (8), viewed in the rolled-up state, is fastened to the spacecraft (1), in particular a payload adapter (4) of the spacecraft (1).

5. A device according to claim 1, characterized in that the insulating mat (8) and/or the shape-changing element (7) is/are equipped with a braking device counteracting the unrolling movement.

6. A device according to claim 5, characterized in that the braking device comprises a releasable connection, in particular a hook-and-loop connection (11,12), between superimposed layers of the rolled-up insulating mat (8) and/or shape-changing element (7).

7. A device according to claim 1, characterized in that the shape-changing element (7) forms an angulation (15) in the extended state.

8. A device according to claim 1, characterized in that adjacent insulating mats (8) overlap each other.

9. A device according to claim 1, characterized in that
the shape-changing element (7) comprises at least one cavity to which medium under pressure can be fed so that the shape-changing element is pneumatically unrolled whereby the shape-changing element forms an inflatable spar (7) extending in the unrolling direction substantially over the entire length of the insulating mat (8) and connected to, or integrated with, the insulating mat (8), and
the insulating mat (8) having radially outer free end when viewed in the rolled-up state, the radially outer free end fastened to the spacecraft (1),
the device further comprises at least one brake for counteracting unrolling movement, and
the insulating mat (8), the shape-changing element (7) or both are equipped with a brake for counteracting their unrolling movement during operative deployment of the deployment means.

10. A device according to claim 9, characterized in that the device includes a plurality of mats (8).

11. A device according to claim 10, characterized in that the device is connected to a spacecraft having at least one cryogenic tank wherein the device is for subsequent deployment to insulate at the least one cryogenic tank on a spacecraft, and, and the plurality of mats (8) are distributed about the periphery of the cryogenic tank.
